(19) United States
(12) Patent Application Publication
(10) Pub. No.: US 2017/0079310 A1
(43) Pub. Date: Mar. 23, 2017

(54) Texture analog dysphagia cuisine

(71) Applicant: Richard Gerry Dingman, JR., Felton, CA (US)

(72) Inventor: Richard Gerry Dingman, JR., Felton, CA (US)

(21) Appl. No.: 14/756,569

(22) Filed: Sep. 18, 2015

(51) Int. Cl. A23F 5/46

(52) U.S. Cl. CPC A23L 1/0526; A23F 5/46; A23L 1/0067; A23V 2002/00

(57) ABSTRACT

An attractive item of dysphagia cuisine does not necessarily have to present itself as a direct imitation of any food product, but its aroma, appearance and taste may present a strong appeal analogous to the texture lost in rendering the food safe to swallow. This texture analog may, in fact, recoup all of the appeal lost in such cuisine. Seasonings traditionally served in a homogenous mix are presented in distinct layers to allow the consumer to experience a rapid succession of tastes at different parts of the tongue. These sensations combine to produce an impression of the customary dish, but with an element of surprise or discovery in the transition from the analog to the relatively homogenous bolus formed prior to swallowing: a process analogous to mastication in a product which did not actually require chewing to be swallowed safely.

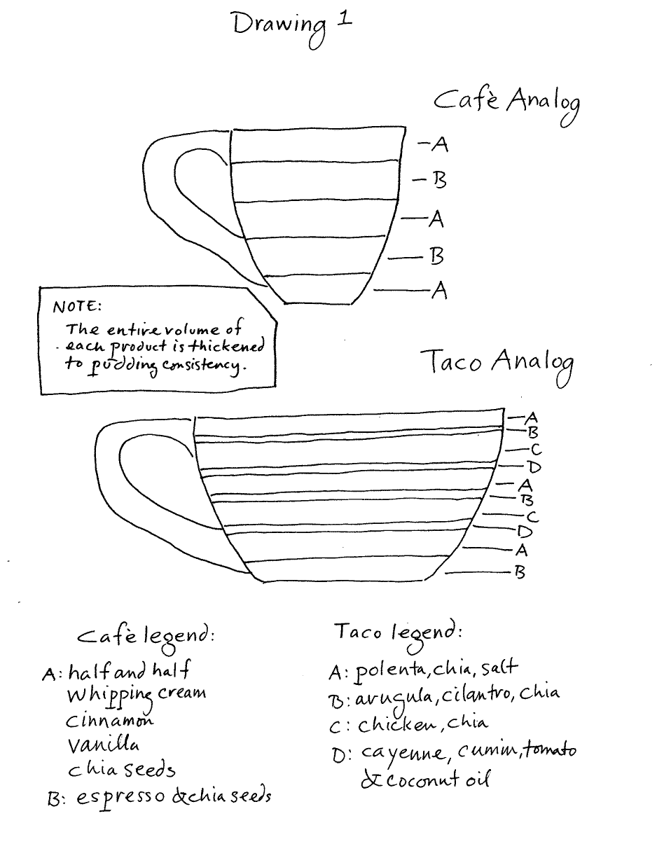

### BACKGROUND

The pureed food served in hospitals leaves much to be desired; it is often incompletely consumed if not refused outright. No one today would simply throw a slice of pizza into the blender—the first example of such cuisine I witnessed in the 80's—nonetheless there is little, if any, time or space within hospital nutrition services departments to develop any new philosophy or method of food preparation and presentation. It is an enormous challenge for both the cook and the clinical dietitian to take into account every prescribed regime, with both personal and ethnic preferences. Problems of chewing and swallowing are still, more or less, handled with the blender.

This problem is not as obscure or as marginal as it may at first sound. In the U.S. population alone, there may be five million having some degree of dysphagia; it's safe to say that most of us will eventually experience some degree of dysphagia ourselves. Those admitted to hospital acute or inpatient rehab facilities face up to three hours of physical, occupational and speech therapy every day. Morale is, in fact, an essential component to the success of these therapeutic regimes. In nearly eight-hundred such facilities, non-acceptance of a dysphagia diet is a persistent and quantifiable problem.

The easiest example which comes to mind is coffee. Nurses and therapists frequently—if not always—start the day with a pint or more of the strongest, most flavorful, calorie laden or calorie-restrained beverage commercially available. Our patients may have been in line at the drive-up of the same coffee house only two weeks prior to admission at a rehab facility. They must now ready themselves for as many as three hours of unfamiliar physical and psychokinetic exercise in the course of the day, not to mention psychometric evaluation. We offer them a modest serving of something weak, starched to almost undrinkable thickness and calorie-less. It is understandably refused. We have all had our coffee: they haven't. This is not acceptable.

Coffee aside, one appealing class of dysphagia cuisine in use today is that of “formed puree”: puree food skillfully crafted into direct imitations of various regional and ethnic cuisines. These are usually one-off examples of culinary art requiring much time and attention. Production of this type of dysphagia cuisine is now routinely available in the UK through DysDine, which markets homogenous puree products molded into direct imitations of traditional English cuisine. Puree chicken shaped into a drumstick, a serving of peas molded into the shape of a mound of peas, &c. I myself have seen memorable examples of formed puree served at what is now called Avamere Olympic Nursing and Rehab in Sequim, Wash. And where I work today, at Community Hospital of the Monterey Peninsula, formed puree occasionally shows up as a quarter-scale slice of french toast—or a portion of scrambled eggs the same size and shape—or a miniature waffle.

### SUMMARY

Formed puree, at its most attractive, is too time-consuming to be employed in the vast majority of hospitals. When it can be produced centrally, the process of rendering in large vats the material to be formed must inevitably produce a taste impression inferior to normal cuisine: such as in the overly rendered cans of “adult baby food” commercially available.

A ready-made item of dysphagia cuisine does not necessarily have to present itself as a direct imitation of any food product, but its aroma, appearance and taste may present a strong appeal analogous to the texture lost in rendering the food safe to swallow. This texture analog may, in fact, recoup all of the appeal lost in such cuisine.

### A DETAILED DESCRIPTION OF THE INVENTION

Seasonings traditionally served in a mix are presented in distinct layers to allow the consumer to experience a rapid succession of tastes at different parts of the tongue. These impressions combine to produce an impression of the customary dish, but with an element of surprise or discovery in the transition from the analog to the relatively homogenous bolus formed prior to swallowing: a process analogous to mastication in something which did not actually require chewing to be swallowed safely.

Such dishes should be nutrient dense: thickened with chia rather than starch to enhance protein and fiber content. The elements may be further separated by thin layers of highly seasoned butter or coconut oil, the bulky layers being relatively bland, enhancing a staccato alternation of tastes to produce a sense of surprise analogous to the breaking down of textured food in the act of chewing. Butter and coconut oil, solid at room temperature enhance the sense of texture without sacrificing safety. The product is nutrient and calorie-dense, portions are small and non-threatening, inviting complete consumption without waste.

The elements should be minimally processed, cooked in small batches and slowly fine-ground or chopped to preserve cell structure in meats and vegetables.

The shape of the container should itself present an element of surprise or variation between different food items. Presentation in a transparent container affirms, at first glance, that the product is not homogenous: appearing crafted, in layers of appealing variation and a decorative surface finish.

1. This is not a simple addition to the list of layered puddings or to those recipes which use strongly varying tastes to create a traditional compound flavor such as bittersweet, sweet & sour or salty caramel. No one has yet presented a system or method of preparing dysphagia cuisine which consistently uses layering for the express purpose of recreating, by analogy, some of that sense of variation lost when either solid food is reduced to puree consistency or when that which is usually consumed as a liquid is thickened to relative unpotability.
I claim here a method for presenting a potentially wide variety of traditional and ethnic cuisine made acceptable in puree form: Single servings with taste elements deliberately de-constructed to produce a pattern of sensation and surprise analogous to mastication will assist in the recovery of that delight normally experienced in traditional food products. To prove my point, I started with coffee; permit me now to relate its successful trial, without which I would never have considered applying for a patent.
On Wednesday, Jul. 22, 2015, at my workplace, the Inpatient Rehabilitation Unit of the Community Hospital of the Monterey Peninsula, at 0730 h, I placed a tray of vanilla café lattes on a table in the office of our Speech Pathologist, Laddie Erbele. There were two eight-ounce glass coffee cups, with glass saucers containing layers of chia-thickenedhoney/vanilla/cinnamon half-and-half, augmented with whipping cream, alternating with chia-thickened layers of coffee concentrate, each cup containing the equivalent of a strong cup of coffee. They were accompanied by four three-ounce espresso sets treated similarly, but with espresso, each containing one-and-a-half shots.
Laddie, with thirty-five years experience as a speech language pathologist, could not taste any of the product, since it was thoroughly sweetened, but declared that this concept revolutionized dysphagia dining.
One of our dietitians, Leslie Pinkerton, took one of the espressos as both coffee and partial meal-substitute, remarking on its protein and fiber content, delighted, too, with the taste and wanting to see more of this kind of thing.
One of our Occupational Therapists, Kathryn Canfield, not a coffee drinker, intending only to taste, inadvertently ingested an entire espresso: giddy the rest of the morning to the amusement of her department.
Many phone pictures were taken and shared, with several staff members—speech language pathologists, dietitians, nurses, physical and occupational therapists—the majority remarking that they would like to see more of this.
Our medical director, Jihad Jaffer, MD, candidly admitted that he had not expected to see anything appealing, but left referring to the presentation as “brilliant”, remarking on the attractive appeal of the layers in transparent cups. He invited me to make a presentation at the regular meeting of our dysphagia group.
Mario Ruiz, OT, MBA, the director of our Inpatient Rehabilitation Unit, spoke both to Dr. Jaffer and to me, advising me not to make any further presentation at CHOMP at this time. He counselled me to seek protection of the idea, since it addressed not only the problem at hand, but seemed potentially adaptable to a broad range of specialty applications.
